(19) United States
(12) Patent Application Publication
(10) Pub. No.: US 2009/0327227 A1
(43) Pub. Date: Dec. 31, 2009

(54) MEETING ROOM AND RESOURCE SCHEDULING AND PRIORITIZATION BASED ON ATTENDEE LOCATION

(75) Inventors: Al Chakra, Apex, NC (US); Julie A. Meserve, Raleigh, NC (US); Stephen M. Meserve, Raleigh, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/147,192

(22) Filed: Jun. 26, 2008

(51) Int. Cl. G06F 15/16; G06F 7/06; G06F 17/30

(52) U.S. Cl. 707/3; 709/204; 707/E17.014

(57) ABSTRACT

A method for meeting room scheduling includes receiving a specification for a meeting, including a list of attendees, and determining respective physical locations for each of the attendees. One or more optimal locations in which to have the meeting is found by calculating which ones of the physical locations has a highest concentration of attendees located there. An optimal room at each of the one or more optimal locations is found by selecting a room that is within a smallest average proximity to a highest number of attendees. The optimal room at each of the one or more optimal locations is then scheduled for the meeting.

### BACKGROUND OF THE INVENTION

Recent years have seen advancement in collaborative approaches and tools for online meetings. However, despite these advancements, the value of face-to-face meetings remains high. In fact, relatively new meeting approaches, such as extreme programming and agile iterative development encourage face-to-face and frequent meetings. Increase of value placed on face-to-face meetings creates some pressure on the efficiency of scheduling meeting rooms. What is needed is a system that can save a user time in finding an appropriate meeting room and that save attendees time walking to the nearest available conference room that has the capacity and equipment necessary for the meeting. Time savings as little as few seconds per attendee per meeting may translate directly to financial savings for a large enterprise per fiscal year.

Conventional meeting management systems exist that can automatically schedule meetings for attendees. But such meeting management systems lack intelligence for scheduling meeting rooms and manual labor is still essential to do so. Basically, after a time and day are chosen for the meeting, traditional meeting management systems require a person to manually enter a meeting room and/or resources into the system, or to select a room and/or resources from a displayed list as needed and as are available.

One drawback to this method is that the scheduler may not have sufficient information about the resources available in the rooms, such as seating capacity or the audio/visual capability of each room, for instance. This means that when selecting from available rooms to schedule, the scheduler must try and remember what rooms have which resources. This can be an error prone process, particularly for a large enterprise having multiple buildings in multiple jobsites, with multiple conference rooms per building. Even with a list of the conference rooms and their resources, the scheduler who is attempting to reserve a room through a traditional room resource management system still must input the room into the system manually.

Another drawback to this method is that the scheduler is limited to being able to select only from those rooms and resources that are available at the time he or she he scheduling the meeting, which may not be the best utilization of the room and or resources. Current room resource management system allows for rooms to be utilized inefficiently, such as for example, when a large group of people is forced to attempt to fit into a smaller meeting room because a room more adequate to the group's size is reserved by a smaller group (e.g., 40 people crammed into a 20 person conference room). Such mistakes in room reservations are typically made unknowingly, and there is believed to be no remedy for this within today's room resource management systems without manual interaction.

Employees are increasing working from home and going on frequent trips. However, people can still attendee meetings remotely by phoning into the meeting from wherever they are—home, traveling, or even from their cubicles. Current room resource management systems, however, only know the total number of attendees of a scheduled meeting and have no way of determining which meeting rooms are optimum for which groups, such that a large room may be booked for a small number of attendees who will be actually physically present at the meeting. This may leave another meeting with a large number of attendees with legitimate needs for a large room deprived from an optimum conference room.

In addition, current room resource management systems make no provisions for how far distant a scheduled room is from its attendees, which may make attendees walk farther than necessary to their meeting room while the financial clock is ticking.

### BRIEF SUMMARY OF THE INVENTION

A method for meeting room scheduling includes receiving a specification for a meeting, including a list of attendees, and determining respective physical locations for each of the attendees. One or more optimal locations in which to have the meeting is found by calculating which ones of the physical locations has a highest concentration of attendees located there. An optimal room at each of the one or more optimal locations is found by selecting a room that is within a smallest average proximity to a highest number of attendees. The optimal room at each of the one or more optimal locations is then scheduled for the meeting.

In another embodiment, a method for meeting room scheduling includes receiving a specification for a meeting, including a date and time of the meeting, a list of attendees, and requested resources. A meeting room and resource scheduler determines which one of the attendees will attend the meeting by being physically present and which ones of the attendees will attend the meeting remotely is determined. Respective physical locations for each of the attendees that will be physically present at the meeting is also determined. One or more optimal locations are found in which to have the meeting by calculating which ones of the physical locations has a highest concentration of the attendees, wherein each of the one or more optimal locations includes one or more rooms. An optimal room at each of the one or more optimal locations is found based on proximity between the attendees and the rooms, and based on the rooms having resources matching the requested resources. And the meeting is scheduled by reserving the optimal room and the resources at each of the one or more optimal locations at the date and the time of the meeting.

### BRIEF DESCRIPTION OF THE DRAWINGS

FIG. 1 is a diagram illustrating a meeting room and resource scheduling and prioritization system according to one exemplary embodiment.

FIG. 2 is a flow diagram illustrating a process for automatic meeting room scheduling according to an exemplary embodiment.

FIG. 3 is a block diagram illustrating a process for meeting room and resource scheduling and prioritization based on attendee location in accordance with an exemplary embodiment.

### DETAILED DESCRIPTION OF THE INVENTION

The present invention relates to a system of method for meeting room and resource scheduling and prioritization based on attendee location. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiments of the present invention provides a system of method for meeting room and resource scheduling and prioritization based on parameters such as a number of attendees physically attending the meeting and each attendee's location, meeting room capacity, meeting room resources, and meeting room physical location, with the goal of providing the most efficient use of rooms and resources available. The exemplary embodiments disclosed herein may be used by a traditional calendar management system to perform room and resource scheduling.

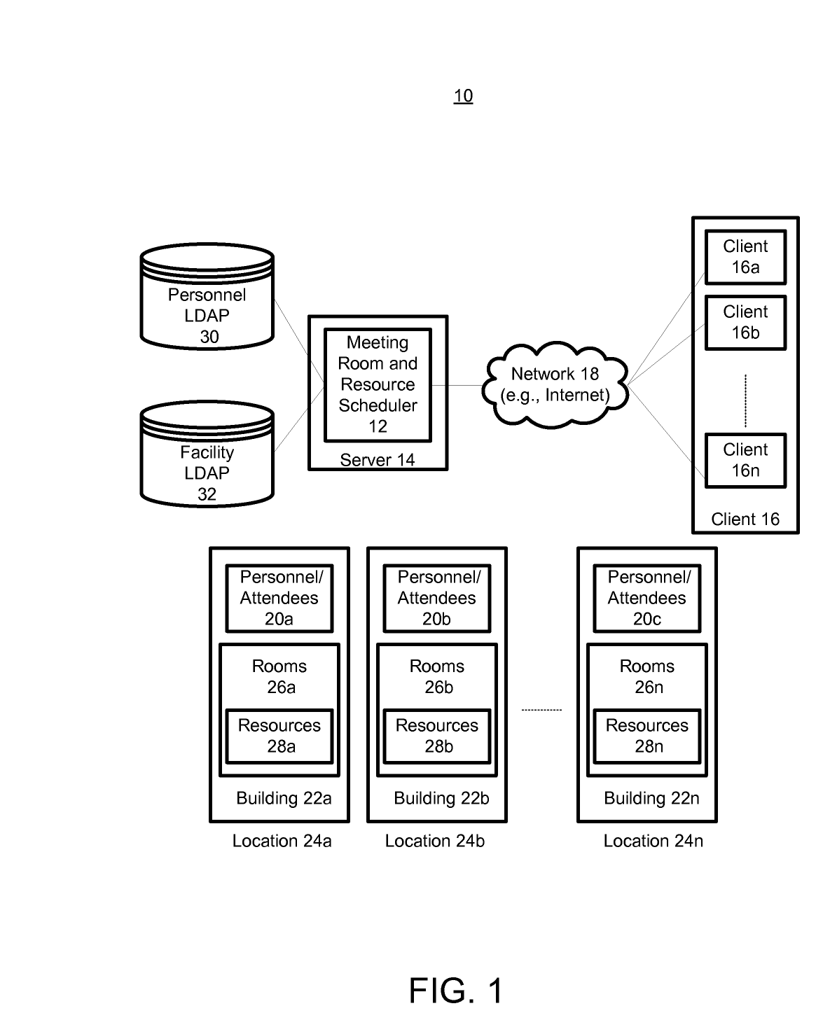

FIG. 1 is a diagram illustrating a meeting room and resource scheduling and prioritization system according to one exemplary embodiment. The system 10 may include a meeting room and resource scheduler 12 executing on a server 14 that is communication with a plurality of clients 16 (16a, 16b, 16n) over a network 18, such as the Internet, or a wireless or wired LAN or WLAN. The meeting room and resource scheduler 12 may be used by an enterprise that may have many different personnel 20 (alternatively referred to as attendees 20) and buildings 22 (22a, 22b, 22n) geographically distributed in many different locations 24 (24a, 24b, 24n). Each of the buildings 22 may one or more rooms 26 (26a, 26b, 26n), and each of the rooms has one or more resources 28 (28a, 28b, 28n).

The meeting room and resource scheduler 12 is a software tool that allows an end-user to place a request for a meeting, and in response, receive a room 26 that has been automatically scheduled, as described further below. The meeting room and resource scheduler 12 is designed to support multiple users and may be web-based. The meeting room and resource scheduler 12 may be accessed by end-users via the clients 16, which in one embodiment may be web browsers. Alternatively, the clients 16 may be implemented as applications that run on end-user computers and interface with the end-user's calendar management applications.

According to an example embodiment, the system further includes a personnel Lightweight Directory Access Protocol (LDAP) 20, and a facility LDAP 23, both of which may be accessed by the meeting room and resource scheduler 12 via the server 14. An LDAP is a networking protocol for querying and modifying information directory services running over Internet protocol. An LDAP directory may include a set of objects with similar attributes organized in a logical and hierarchical manner.

The facility LDAP 32 may store organizational and geographic location information for each facility or building 22 of an enterprise, entity, or organization, including a list of rooms 26 in each building 22, and a location of the rooms 26 in each building 22 by floor number, row number and door number. The facility LDAP 32 may also store the resources 28 available in each of the rooms 26. Resources 28 may include items such as seating capacity; room type (e.g., conference room, auditorium); and hardware/audiovisual equipment such as television, projector, screen, teleconference, phone system, camera, computers, and the like.

The personnel LDAP 30 may store information about the personnel 20 belonging to, or associated with, an enterprise, entity, or organization, and who may be invited to attend meetings (i.e., the attendee 20). The personnel LDAP 30 may include contact, organizational, and geographic office location information for each of the personnel 20. Information in the personnel LDAP 30 may be represented in a tree structure. For example, the geographic location information might include entries for each personnel's address (including country, city and state), building number, floor number, cubicle or office number, row number and seat number).

In another embodiment, the personnel LDAP 30 and the facility LDAP 32 could be implemented as less than or greater number than two LDAPs, or may be implemented as any other type of directory, database, repository, or table.

Although the exemplary embodiment is shown in an enterprise environment in which the meeting room and resource scheduler 12 is server 14 based, in an alternative embodiment, the meeting room and resource scheduler 12 may be implemented as a stand-alone application that runs on the end-user computer.

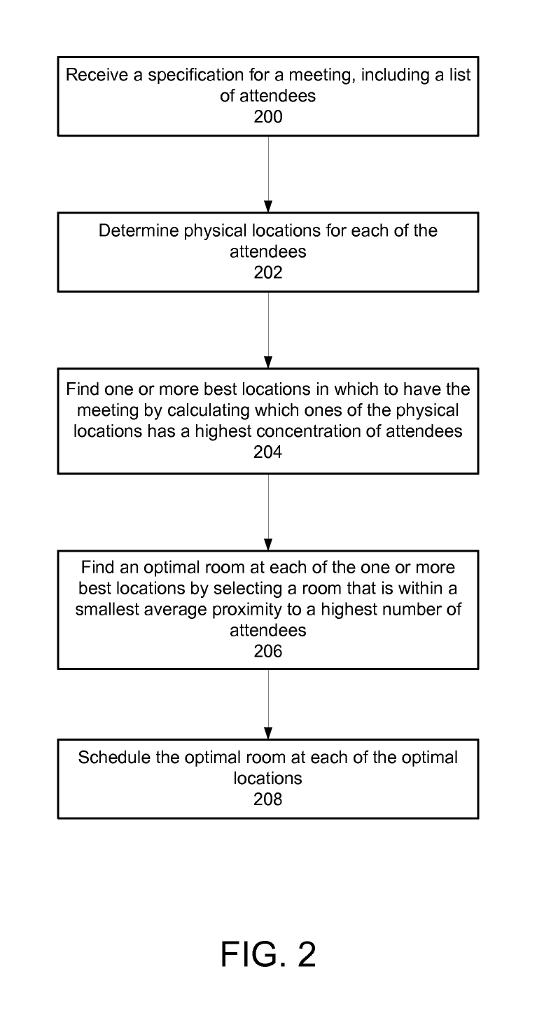

FIG. 2 is a flow diagram illustrating a process for automatic meeting room scheduling according to an exemplary embodiment. The process may begin when the meeting room and resource scheduler 12 receives a specification for a meeting, including a list of attendees 20 (block 200). The physical locations 24 for each of the attendees 20 are then determined (block 202). The physical location may be determined by querying the personnel LDAP 30 of with names of the attendees 20 and retrieving location information for each of the attendees 20.

The meeting room and resource scheduler 12 finds one or more optimal locations in which to have the meeting by calculating which ones of the physical locations 24 has a highest concentration of attendees 20 located there (block 204). Determining the highest concentration of attendees 20 in each location may be performed by querying the personnel LDAP 30 and the facility LDAP 32 and counting the number of the attendees 20 located at each of the physical locations 24. This process may result in multiple optimal locations.

As an example, consider a situation where a meeting is to be scheduled for an enterprise that has facilities in locations 24 the USA, Canada, Austria and Germany. Assume further that the meeting will be attended by four teams; a team in the USA of ten people, a team in Canada of two people, a team in Austria of three people, and a team in Germany of twelve people. The meeting room and resource scheduler 12 may determine based on the number of attendees at each location and other configuration preferences (e.g., distances between facility locations) that two optimal meeting locations is preferable, one location in the USA and one location in Germany, over selecting just one location in either the USA or in Germany, for example.

The optimal room at each of the optimal locations is then found by selecting a room 26 located in each of the optimal locations that is within a smallest average proximity to a highest number of attendees 20 (block 206). The optimal room in each of the optimal locations may be found by calculating a distance between each attendee's location (e.g., address, building number, floor number, cubicle or office number, row number and seat number) and the optimal room location (which may be retrieved from the facility LDAP 32 (e.g., floor number, row number and door number)), and computing the average distance of all the attendees 20.

The meeting room and resource scheduler 12 then schedules the optimal room at each of the optimal locations for the meeting (block 208). As part of the scheduling task, the meeting room and resource scheduler 12 may automatically notify each of the attendees 20 of the scheduled room.

According to a further aspect of the exemplary embodiment, after the optimal locations to have the meeting are found by calculating which physical locations 24 has the highest concentration of attendees 20, the optimal room is found based not only on the proximity between the attendees 20 and the rooms 26 in the same location, but also based on determining whether the rooms 26 match the resource requirements of the meeting.

One resource requirement that may be matched is the seating capacity of the rooms 26. According to the exemplary embodiment, matching the seating capacity of the rooms 26 to the seating capacity requirements of the meeting requires a comparison of the number of attendees 20 that will physically attend the meeting versus the attendees 20 who will attend remotely (e.g., calling-in, e-meeting, etc.). According to a further aspect of the exemplary embodiment, the meeting room and resource scheduler 12 may use personnel behavior (current and future) to automatically determine whether attendees 20 will physically attend the meeting or attending remotely, as explained below.

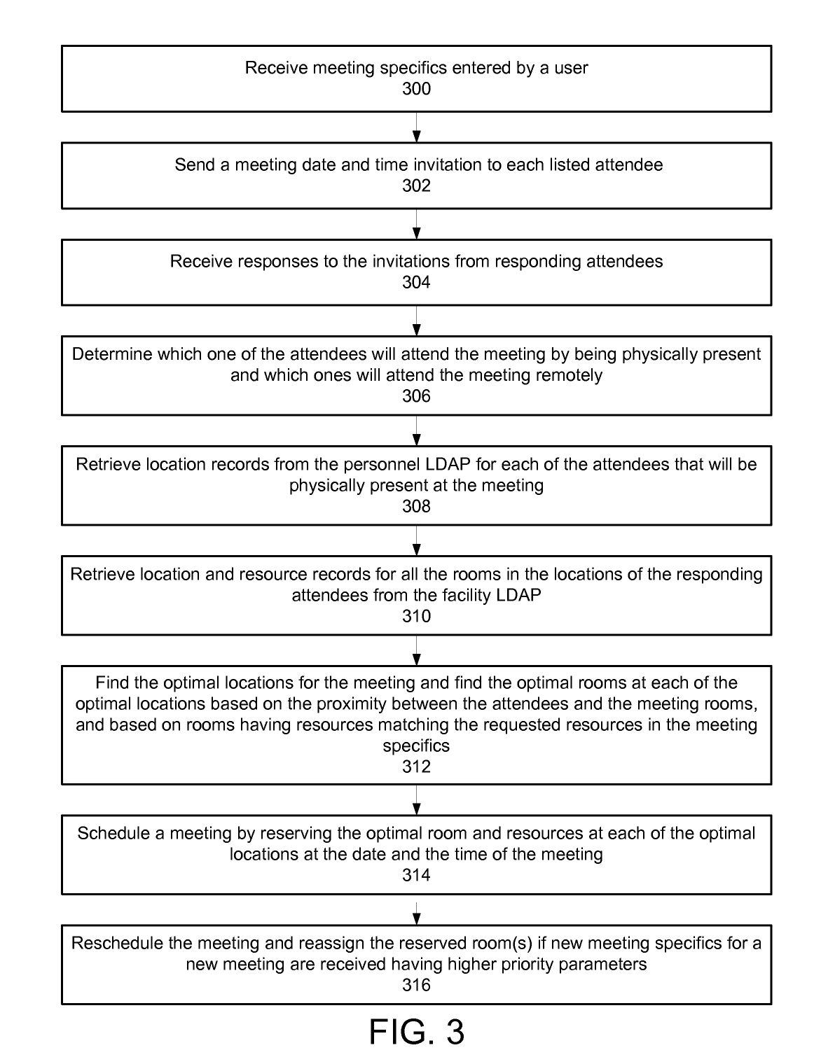

FIG. 3 is a block diagram illustrating a process for meeting room and resource scheduling and prioritization based on attendee location in accordance with an exemplary embodiment. The process may begin by the meeting room and resource scheduler 12 receiving meeting specifics entered by a user from a client 16 (block 300). The meeting specifics may include parameters including a date, time, requested resources 28, and a list of attendees 20. In one embodiment, the meeting specifics are entered into a GUI display by the meeting room and resource scheduler 12. The meeting room and resource scheduler 12 may display a list of available resources 28 for user selection, and may display a searchable contact list for entering attendees 20.

In response to receiving the meeting specifics, the meeting room and resource scheduler 12 electronically sends a meeting date and time invitation to each listed attendee (block 302), and receives responses to the invitations from responding attendees 20 (block 304).

The meeting room and resource scheduler 12 determines which one of the attendees 20 will attend the meeting by being physically present and which ones of the attendees 20 will attend the meeting remotely (306). In one embodiment, determining which attendees 20 will be physically present and which ones will attend the meeting remotely can be determined directly from the responses to the invitations. In one embodiment, non-responding attendees 20 may be treated as attending in person.

However, in another embodiment, the meeting room and resource scheduler 12 can automatically determine which attendees 20 will attend remotely based on current and future behaviors, and respond to the invitations for the attendees 20 accordingly. Current behaviors may be determined by examining past invitation responses from each attendee. If for example, if a particular attendee always declines to attend meetings personally on Tuesday, then it can be inferred that the next meeting invitation received for a Tuesday meeting will be likewise declined to be personally attended by this attendee.

Future behaviors may be determined by accessing a calendaring program of each attendee or scheduling database and determining what days each attendee is scheduled to be out of office for reasons such as “working from home” or “traveling” for example. If a meeting invitation is received for a date and time that occurs on the same date and time that it attendee is scheduled to be “out of the office”, then the meeting room and resource scheduler 12 may automatically determine that this attendee will decline to personally attend this meeting.

The meeting room and resource scheduler 12 then retrieves location records from the personnel LDAP 30 for each of the attendees 20 that will be physically present at the meeting (block 308). The meeting room and resource scheduler 12 also retrieves location and resource records for all the rooms 26 in the locations 24 of the responding attendees 20 from the facility LDAP 32 (block 310).

After retrieving the records, the meeting room and resource scheduler 12 finds the optimal locations for the meeting and finds the optimal rooms 26 at each of the optimal locations based on the proximity between the attendees 20 and the meeting rooms 26 (as described above), and based on rooms 26 having resources 28 matching the requested resources 28 in the meeting specifics (block 312).

In one embodiment, the meeting room and resource scheduler 12 may automatically determine if a selected room 26 has resources 28 matching the requested resources 28 by ensuring that the number of attendees 20 physically present at the meeting is not greater than a seating capacity of a selected room 26 and within a predetermined range of being less than the seating capacity of the selected room; and that the selected room 26 has any hardware requirements specified in the requested resources 28.

The meeting room and resource scheduler 12 schedules a meeting by reserving the optimal room and resources 28 at each of the optimal locations at the date and the time of the meeting (314). The meeting room and resource scheduler 12 may reschedule the meeting and reassign the reserved room(s) if new meeting specifics for a new meeting is received having higher priority parameters (block 316). In one embodiment, the meeting with the highest number of physically attending attendees 20 will be scheduled a room 26 in case of a conflict, even if the meeting is scheduled after another meeting, for efficiency purposes. In another embodiment, a predetermined lockout period, such as 24 hours, may be placed on the rescheduling rooms 26.

The above principles will now be explained by way of example. In this example, assume that an enterprise has facilities located in the USA, Germany, and China, and has many Teams distributed throughout its facilities. Assume further that Teams 1 through 4 need to schedule meetings where:

Team One comprises 10 people in the USA facility, 5 people in Germany, and 10 people in China;

Team Two comprises 20 people in the USA;

Team Three comprises 15 people in the USA; and

Team Four comprises 20 people in the USA.

Assume that the Team One lead sends a meeting specification for his group to the meeting room and resource scheduler 12, and that the meeting room and resource scheduler 12 sends a meeting date and time invitation to all team members. If all members from USA will be attending in person, 3 team members in Germany will be on site, but 2 will be remote, and the 10 team members in China will be on site, the meeting room and resource scheduler 12 will find and schedule an optimal room in the USA, in Germany, and in China for those team members attending in person.

Now assume that the Team Two lead schedules a meeting for his group on the same day as the Team One meeting. The meeting room and resource scheduler 12 sends a meeting date and time invitation to all 20 Team Two members in the USA. If 9 of the team members will be attending in person and 11 will be remote, then the meeting room and resource scheduler 12 will find in schedule an optimal room in the USA for these 9 people. Also, this meeting will take second precedence to the Team One meeting due to the smaller number of attendees 20 in this meeting.

Assume further that the Team Three lead uses the meeting room and resource scheduler 12 to schedule a meeting 3 days after the Team One lead, but that the Team Three meeting day is two days before the Team One team meeting. The meeting room and resource scheduler 12 sends a meeting date and time limitation to all Team Three members which consists of 15 people in USA, 2 in Germany, and 20 in China. If all 15 team members from USA will be attending in person, the 2 people in Germany will be remote, and all 20 people in China will attend in person, the meeting room and resource scheduler 12 will find and schedule an optimal room in the USA and in China, but no meeting room in Germany will be reserved, as all replied attending remotely.

If Team Three and Team One personnel 20 sit in close proximity in the USA, then Team Three meeting would overrule the Team One meeting and force the Team One meeting to be assigned to a new room 26 location due to Team Three having more members in the USA than Team One.

Now assume that the Team Four lead schedules a meeting in USA 16 hours before the Team Three meeting and that all 20 Team Four members reply to the meeting invitation that they will be attending in person. The meeting room in resource scheduler 12 does not move the Team Three meeting because the team three meeting is within the 24 hour lock down time of their meeting.

A system of method for system of method for meeting room and resource scheduling and prioritization based on attendee location has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for meeting room scheduling, comprising:
receiving a specification for a meeting, including a list of attendees;
determining respective physical locations for each of the attendees;
finding one or more optimal locations in which to have the meeting by calculating which ones of the physical locations has a highest concentration of the attendees located there;
finding an optimal room at each of the one or more optimal locations by selecting a room that is within a smallest average proximity to a highest number of attendees; and
scheduling the optimal room at each of the one or more optimal locations for the meeting.

2. The method of claim 1 wherein finding the optimal room in each of the one or more optimal locations further comprises selecting the room located in each of the one or more optimal locations that match resource requirements of the meeting.

3. The method of claim 2 wherein the resource requirements comprises seating capacity, and wherein matching the seating capacity of the room and the seating capacity requirements of the meeting requires a comparison of a number of the attendees that will physically attend the meeting versus the attendees who will attend remotely.

4. The method of claim 3 wherein the determining the number of the attendees that will physically attend the meeting further comprises at least one of:
sending invitations to the meeting to the attendees and receiving responses indicating whether the attendees will physically attend the meeting or attend remotely; and
using personnel behavior to automatically determine whether the attendees will physically attend the meeting or attending remotely.

5. The method of claim 1 wherein the determining respective physical locations for each of the attendees further comprises querying a personnel directory with names of the attendees and retrieving location information for each of the attendees.

6. The method of claim 5 further comprising determining the highest concentration of the attendees in each of the physical locations by querying the personnel directory and a facility directory and counting a number of the attendees located at each of the physical locations.

7. The method of claim 6 wherein finding the optimal room in each of the one or more optimal locations further comprises calculating a distance between each attendee's location and an optimal room location from the facility directory, and computing an average distance.

8. The method of claim 7 further comprising retrieving location information for each attendee from the personnel directory, the location information including an address, a building number, a floor number, and a cubicle or an office number.

9. The method of claim 1 wherein the scheduling the optimal room for the meeting further comprises scheduling the meeting by reserving the optimal room and resources at each of the one or more optimal locations at a date and a time of the meeting.

10. The method of claim 9 further comprising rescheduling the meeting and reassign the reserved room if a new specification for a new meeting is received having higher priority parameters.

11. A system comprising:
a server;
a meeting room and resource scheduler executing on the server; and
wherein in response receiving a specification for a meeting from a client, including a list of attendees, the meeting room and resource scheduler application functions to:
determine respective physical locations for each of the attendees;
find one or more optimal locations in which to have the meeting by calculating which ones of the physical locations has a highest concentration of the attendees located there;
find an optimal room at each of the one or more optimal locations by selecting a room located in each of the one or more optimal locations that is within a smallest average proximity to a highest number of the attendees; and
schedule the optimal room at each of the one or more optimal locations for the meeting.

12. The system of claim 11 wherein the meeting room and resource scheduler finds the optimal room in each of the one or more optimal locations by selecting the room located in each of the one or more optimal locations that match resource requirements of the meeting.

13. The system of claim 12 wherein the resource requirements comprises seating capacity, and wherein matching the seating capacity of the room and the seating capacity requirements of the meeting is performed by comparing a number of the attendees that will physically attend the meeting versus the attendees who will attend remotely.

14. The system of claim 13 wherein the meeting room and resource scheduler determines the number of the attendees that will physically attend the meeting by at least one of:
sending invitations to the meeting to the attendees and receiving responses indicating whether the attendees will physically attend the meeting or attend remotely; and
using personnel behavior to automatically determine whether the attendees will physically attend the meeting or attending remotely.

15. The system of claim 11 wherein the meeting room and resource scheduler determines respective physical locations for each of the attendees by querying a personnel directory with names of the attendees and retrieving location information for each of the attendees.

16. The system of claim 15 wherein the meeting room and resource scheduler determines the highest concentration of the attendees in each of the physical locations by querying the personnel directory and a facility directory and counting a number of the attendees located at each of the physical locations.

17. The system of claim 16 wherein the meeting room and resource scheduler finds the optimal room in each of the one or more optimal locations by calculating a distance between each attendee's location and an optimal room location from the facility directory, and computing an average distance.

18. The system of claim 17 wherein the meeting room and resource scheduler retrieves location information for each attendee from the personnel directory, the location information including an address, a building number, a floor number, and a cubicle or an office number.

19. The system of claim 11 wherein the meeting room and resource scheduler schedules the optimal room for the meeting by scheduling the meeting and by reserving the optimal room and resources at each of the one or more optimal locations at a date and the time of the meeting.

20. The system of claim 19 wherein the meeting room and resource scheduler reschedules the meeting and reassigns the reserved room if a new specification for a new meeting is received having higher priority parameters.

21. A computer-implemented method for meeting room scheduling, comprising:
receiving a specification for a meeting, including a date and time of the meeting, a list of attendees, and requested resources;
determining which one of the attendees will attend the meeting by being physically present and which ones of the attendees will attend the meeting remotely;
determining respective physical locations for each of the attendees that will be physically present at the meeting;
finding one or more optimal locations in which to have the meeting by calculating which ones of the physical locations has a highest concentration of the attendees, wherein each of the one or more optimal locations includes one or more rooms;
finding an optimal room at each of the one or more optimal locations based on a proximity between the attendees and the rooms, and based on the rooms having resources matching the requested resources; and
scheduling the meeting by reserving the optimal room and the resources at each of the one or more optimal locations at the date and the time of the meeting.
